(19) United States
(12) Patent Application Publication
(10) Pub. No.: US 2025/0372762 A1
(43) Pub. Date: Dec. 4, 2025

(54) BATTERY PACK ASSEMBLY AND MANUFACTURING METHOD THEREOF

(71) Applicants: HYUNDAI MOTOR COMPANY, Seoul (KR); KIA CORPORATION, Seoul (KR); VALEO KAPEC CO., LTD., Daegu (KR)

(72) Inventors: Hyun Chang Kang, Hwaseong-si (KR); Jun Seok Choi, Hwaseong-si (KR); Cheol Gyu Woo, Daegu (KR); Hyung Dong Yeo, Daegu (KR); Ki Hong Lee, Daegu (KR); Su Bin Uem, Daegu (KR); Kyung Wook Nam, Daegu (KR)

(73) Assignees: HYUNDAI MOTOR COMPANY, Seoul (KR); KIA CORPORATION, Seoul (KR); VALEO KAPEC CO., LTD., Daegu (KR)

(21) Appl. No.: 18/970,519

(22) Filed: Dec. 5, 2024

(30) Foreign Application Priority Data
May 28, 2024 (KR) 10-2024-0068991

(51) Int. Cl. H01M 10/6563; B60L 50/64; H01M 10/613; H01M 10/625; H01M 10/6566; H01M 50/211

(52) U.S. Cl. CPC H01M 10/6563; B60L 50/64; H01M 10/613; H01M 10/625; H01M 10/6566; H01M 50/211; H01M 2220/20

(57) ABSTRACT

A battery pack assembly and a manufacturing method thereof are disclosed. The battery pack assembly includes a cell cartridge assembly formed by stacking cartridge blocks and battery cells and includes an inlet duct coupled to the cell cartridge assembly to form a flow space therebetween. The flow space allows air introduced through a cooling air inlet to flow therethrough and distributes the air to cooling passages of the stacked cartridge blocks. The battery pack assembly further includes an outlet duct coupled to the cell cartridge assembly and configured to discharge the air therethrough, a blower configured to suction air, and a flow resistance member disposed on the bottom of the inlet duct and configured to partially block the air flowing along the flow space so that the air temporarily stays on the upstream side.

### CROSS-REFERENCE TO RELATED APPLICATION

This application claims, under 35 U.S.C. § 119 (a), the benefit of and priority to Korean Patent Application No. 10-2024-0068991, filed on May 28, 2024, the entire contents of which are incorporated herein by reference.

### BACKGROUND

### (a) Technical Field

The present disclosure relates to a battery pack assembly and a manufacturing method thereof, and more particularly, to a vehicle battery pack assembly mounted in a vehicle and configured to supply power to an electric device of the vehicle, and to a manufacturing method thereof.

### (b) Background Art

A secondary battery is easily applied to various products and has electrical characteristics such as high energy density. Accordingly, a secondary battery is generally used in various portable devices and including in an electric vehicle (EV) and a hybrid electric vehicle (HEV) that are driven by an electric driving source.

Such a secondary battery has an advantage of dramatically reducing the use of fossil fuels and completely preventing generation of any by-products due to the use of energy. Accordingly, the secondary battery has been regarded as a new energy source for environmentally friendly energy with high energy efficiency.

Normally, since the operating voltage of a secondary battery unit cell is lower than the required voltage, a battery is formed by connecting multiple secondary battery cells in series in order to respond to high output voltage demand. Depending on the required charging/discharging capacity, a battery may be formed by connecting multiple secondary battery cells in parallel. As described above, the number of secondary battery cells provided in the battery may be adjusted in various ways depending on the required output voltage or charging/discharging capacity.

A battery pack assembly (BPA) used as a vehicle battery is manufactured by stacking battery modules having battery cells assembled therein.

Each of the battery modules forming the battery pack assembly includes a battery cell, a high voltage terminal provided to charge and discharge the battery cell, and a high voltage bus bar configured to electrically connect the high voltage terminals to each other and to connect the high voltage terminal to an external circuit.

In a typical vehicle battery pack assembly, a pouch-type battery cell is widely used as a secondary battery cell, and a battery module is formed by electrically connecting a plurality of the battery cells to each other. The vehicle battery pack assembly is normally formed by adding other components to a plurality of the battery modules as needed.

A vehicle battery pack assembly using a pouch-type battery cell has higher space utilization than a vehicle battery pack assembly using a cylindrical battery cell. Additionally, the vehicle battery pack assembly using the pouch-type battery cell has higher energy density than that of a vehicle battery pack assembly using a square battery cell. The vehicle battery pack assembly using the pouch-type battery cell has a disadvantage in that it is not easy to control heat.

When heat of a battery cell is not appropriately controlled, the temperature of a battery module increases. This may cause deterioration in performance and malfunction of a device having the battery module applied thereto.

A vehicle battery pack assembly using a conventional pouch-type battery cell has a cooling structure in which air suctioned by a blower passes through battery cells so as to cool the battery cells.

More specifically, an inlet duct is coupled to an upper portion of a cell cartridge assembly formed by stacking a plurality of cartridge blocks and pouch-type battery cells. An outlet duct is coupled to an end side in the longitudinal direction of the cell cartridge assembly. A blower is installed at the outlet side of the outlet duct.

When the blower is driven, air is suctioned into a cooling air inlet of the inlet duct by the blower and air suctioned through the cooling air inlet moves through a space formed between the inlet duct and the cell cartridge assembly. Thereafter, air moves downward between the battery cells accommodated in the cartridge block of the cell cartridge assembly.

In the cell cartridge assembly, a plurality of cartridge blocks is stacked, and one or more pouch-type battery cells are accommodated in each space between a pair of stacked cartridge blocks. Air introduced through the cooling air inlet of the inlet duct flows along a space formed between the stacked cartridge blocks and the inlet duct disposed on the upper side thereof.

Air then moves along the lower surface of the inlet duct and is distributed from the space above the cartridge block to cooling passages formed in each of the cartridge blocks. Thereafter, air is introduced into the battery cells through the cooling passages of the stacked cartridge blocks so as to pass through a space between the battery cells.

In this manner, air passes through the space between the battery cells so as to cool the battery cells. Thereafter, air that has passed through the battery cells is discharged to the bottom of the cartridge blocks and then moves toward the outlet duct. Air then moves to the blower along the outlet duct and is finally discharged through an outlet provided on one side of the blower.

However, a conventional battery pack assembly has a shape extending in a direction in which cartridge blocks and battery cells are stacked. Therefore, there is a problem in that air introduced through a cooling air inlet of an inlet duct does not uniformly flow along the inlet duct and is concentrated in some areas.

In other words, an imbalance occurs in the amount of cooling fluid (air) flowing into cartridge blocks depending on the positions of the cartridge blocks relative to the position of the cooling air inlet of the inlet duct. As a result, the battery cells may not be evenly cooled.

Accordingly, battery cells accommodated in some cartridge blocks disposed at a certain distance from the cooling air inlet of the inlet duct may be less cooled or cooled more than battery cells accommodated in other cartridge blocks. As a result, a temperature difference may occur between the battery cells, leading to deterioration in cooling performance.

The above information disclosed in this Background section is only to enhance understanding of the background of the disclosure. Therefore, Background section may contain information that does not form the prior art that is already known to a person of ordinary skill in the art.

### SUMMARY

The present disclosure has been made in an effort to solve the above-described problems associated with the prior art. It is an object of the present disclosure to provide a battery pack assembly configured to uniformly distribute air regardless of the positions of cartridge blocks and battery cells relative to the position of an inlet duct so as to uniformly cool all of the battery cells. It is another object of the present disclosure to provide a manufacturing method of the battery pack assembly.

The objects of the present disclosure are not limited to the above-mentioned objects. Other technical objects not mentioned herein should be more clearly understood by those having ordinary skill in the art to which the present disclosure pertains from the detailed description of the embodiments.

In one aspect, the present disclosure provides a battery pack assembly. The battery pack assembly includes a cell cartridge assembly. The cell cartridge assembly includes one or more battery cells, one or more cartridge blocks configured to fix the battery cells, and cooling passages configured to allow cooling air for cooling of the one or more battery cells to flow therethrough. The battery pack assembly further includes an inlet duct including a cooling air inlet. The inlet duct is coupled to one side surface of the cell cartridge assembly so as to form a flow space therebetween. The flow space allows the cooling air inlet and the cooling passages to communicate with each other and guides the cooling air introduced through the cooling air inlet to the cooling passages. The battery pack assembly also includes a flow resistance member configured to block at least a part of the cooling air flowing along the flow space.

In an embodiment, the flow resistance member may be disposed on a surface facing the one side surface of the cell cartridge assembly.

In another embodiment, the flow resistance member may be disposed to extend in a traverse direction relative to a flow direction of the air flowing along the flow space.

In still another embodiment, the flow resistance member may be an ethylene propylene diene monomer (EPDM) pad and may be attached to the inlet duct with an adhesive.

In yet another embodiment, the cell cartridge assembly may be formed by stacking a plurality of the battery cells and a plurality of the cartridge blocks. The inlet duct may have a shape extending in a stacking direction of the battery cells and the cartridge blocks. The cooling air inlet may be disposed at one end of the inlet duct in the stacking direction.

In still yet another embodiment, the battery pack assembly may further include a forced flow means, such as a blower or other type of forced air moving device configured to forcibly flow the cooling air.

In a further embodiment, the battery pack assembly may further include an outlet duct disposed on the other side surface of the cell cartridge assembly.

In another further embodiment, the forced flow means or blower may be disposed on a side of the outlet duct.

In still another further embodiment, the inlet duct may be formed to be inclined toward the cell cartridge assembly in a direction going away from the cooling air inlet and approaching the cell cartridge assembly.

In another aspect, the present disclosure provides a manufacturing method of the battery pack assembly according to an embodiment of the present disclosure. The manufacturing method includes a characteristic determination step of determining a characteristic of the flow resistance member. The characteristic determination step includes a first step of measuring temperatures of one or more of the cartridge blocks or one or more of the battery cells. The characteristic determination step further includes a second step of determining, based on measurement results of the temperatures, one or more of an arrangement position, a thickness, or a length of the flow resistance member.

In an embodiment, the second step may include determining the arrangement position of the flow resistance member. A position downstream of a cooling air flow direction of any one of the cartridge blocks or the battery cells having a temperature value among the measurement results of the temperatures may be determined as the arrangement position of the flow resistance member. The temperature value may be higher than a predetermined target cooling temperature value.

In another embodiment, the second step may include determining the length of the flow resistance member. The length of the flow resistance member may be determined depending on a temperature difference value between the adjacent cartridge blocks or between the adjacent battery cells among the measurement results of the temperatures.

In still another embodiment, the second step may include determining the thickness of the flow resistance member. The thickness of the flow resistance member may be determined depending on a temperature difference value between the adjacent cartridge blocks or between the adjacent battery cells among the measurement results of the temperatures.

It should be understood that the terms “vehicle”, “vehicular”, and other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are now described in detail with reference to certain embodiments thereof illustrated in the accompanying drawings, which are given hereinbelow by way of illustration only, and thus are not limitative of the present disclosure, and wherein:

FIG. 1 is a side view showing a battery pack assembly according to an embodiment of the present disclosure;

FIG. 2 is a view showing a state in which a flow resistance member is installed on the lower surface of an inlet duct according to an embodiment of the present disclosure;

FIG. 3 is a perspective view showing the position of the flow resistance member relative to a cell cartridge assembly in a state in which the inlet duct is assembled according to an embodiment of the present disclosure;

FIG. 4 is a cross-sectional view showing the battery cells and the cartridge blocks of the cell cartridge assembly according to an embodiment of the present disclosure.

FIG. 5 is a view showing the temperature of a cartridge block measured for a battery pack assembly without the flow resistance member and the battery pack assembly having the flow resistance member attached thereto;

FIG. 6 is a view showing the temperature of each cartridge block measured by varying a length of the flow resistance member installed in a battery pack assembly according to an embodiment of the present disclosure;

FIG. 7 is a plan view showing the position of the flow resistance member relative to the cell cartridge assembly in a state in which the inlet duct is assembled according to an embodiment of the present disclosure;

FIG. 8 is a view showing the temperature of each cartridge block measured by varying a thickness of the flow resistance member installed in a battery pack assembly according to an embodiment of the present disclosure;

FIG. 9 is a view showing a flow state of air introduced through a cooling air inlet of the inlet duct in a battery pack assembly according to an embodiment the present disclosure; and

FIG. 10 and FIG. 11 are views each showing the results of measuring the temperatures of all the cartridge blocks in the battery pack assemblies of the related art and an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Hereinafter, embodiments of the present disclosure are described in detail with reference to the attached drawings. Specific structural or functional descriptions given in connection with the embodiments of the present disclosure are merely illustrative for the purpose of describing embodiments according to the concept of the present disclosure. Embodiments according to the concept of the present disclosure may be implemented in various forms. Further, it should be understood that the present description is not intended to limit the disclosure to the embodiments. On the contrary, the disclosure is intended to cover the embodiments, as well as various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component. However, it should be understood that other components may be present therebetween. On the other hand, when the one component is referred to as being “directly connected to” or “directly in contact with” the other component, it should be understood that other components are not present therebetween. Other expressions for the description of relationships between components, i.e., “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

The present disclosure relates to a rechargeable secondary battery, and more particularly, to a battery pack assembly formed by connecting a plurality of battery cells to each other and to a manufacturing method thereof. In particular, the battery pack assembly according to an embodiment of the present disclosure may be mounted in an electric vehicle or a hybrid vehicle so as to supply power to a high-voltage electric device in the vehicle.

The battery pack assembly according to an embodiment of the present disclosure may be connected to a motor serving as a driving device for driving of an electric vehicle or a hybrid vehicle in a chargeable and dischargeable manner so as to supply power to the motor or to receive power therefrom.

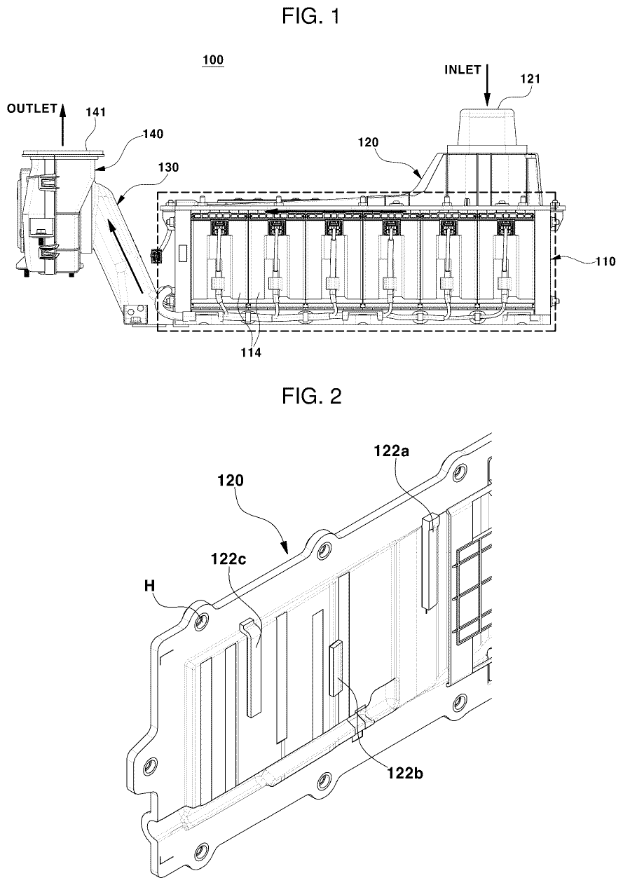

FIG. 1 is a side view showing a battery pack assembly according to an embodiment of the present disclosure and is a view showing a cooling fluid flow state in the battery pack assembly. A cooling fluid is air, and the air, which is the cooling fluid, is suctioned into the interior of a battery pack assembly 100 by a blower 140.

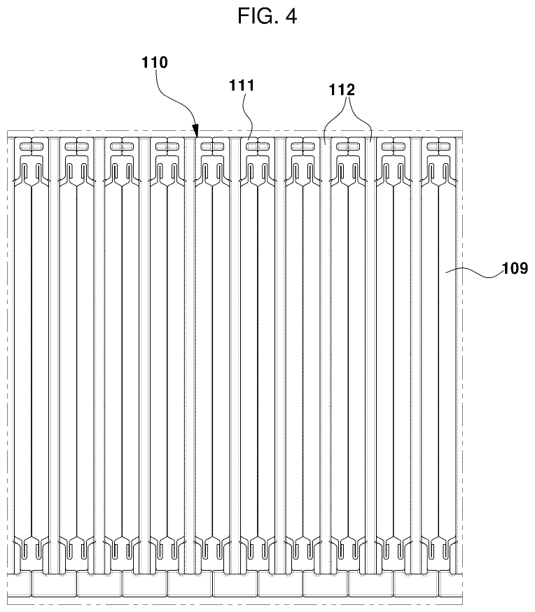

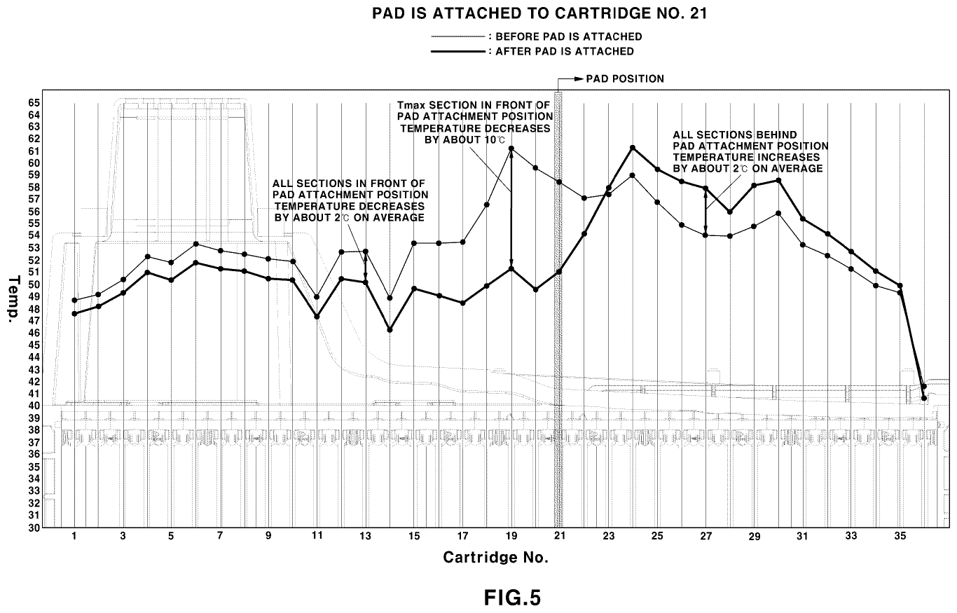

The battery pack assembly 100 according to an embodiment of the present disclosure may include a cell cartridge assembly 110 including one or more battery cells (reference numeral “109” in FIG. 4), one or more cartridge blocks (reference numeral “111” in FIG. 3 and FIG. 4) configured to fix the battery cells, and a cooling passage (reference numeral “112” in FIG. 3 and FIG. 4) configured to allow cooling air for cooling of the one or more battery cells to flow therethrough. The battery pack assembly 100 may also include an inlet duct 120 including a cooling air inlet 121. The inlet duct 120 is coupled to one side surface of the cell cartridge assembly 110 so as to form a flow space configured to allow the cooling air inlet 121 and the cooling passage 112 to communicate with each other and to guide the cooling air introduced through the cooling air inlet 121 to the cooling passage 112. The inlet duct 120 has flow resistance members 122a, 122b, and 122c configured to block at least a part of the cooling air flowing along the flow space.

In addition, the battery pack assembly 100 according to an embodiment of the present disclosure may further include a forced flow means, such as a blower and associate hardware and passages, configured to forcibly flow the cooling air. In addition, the battery pack assembly 100 according to an embodiment of the present disclosure may further include an outlet duct 130 disposed on the other side surface of the cell cartridge assembly 110.

The forced flow means may be disposed on the outlet duct 130 side. Additionally, the inlet duct 120 may be formed to be inclined toward the cell cartridge assembly 110 in the direction going away from the cooling air inlet 121 and approaching the cell cartridge assembly 110.

According to an embodiment shown in the drawings, the inlet duct 120 may be coupled to the upper side of the cell cartridge assembly 110 and the outlet duct 130 may be coupled to the end side of the cell cartridge assembly 110. Additionally, the forced flow means may include the blower 140 coupled to the outlet side of the outlet duct 130.

The cell cartridge assembly 110 includes a plurality of battery modules (not shown). The number of battery modules constituting the cell cartridge assembly may be changed depending on a required voltage specifications or an installation structure.

Additionally, each battery module may be configured to include a plurality of battery cells (reference numeral “109” in FIG. 4) and a plurality of the cartridge blocks (reference numeral “111” in FIG. 3 and FIG. 4). Each of the battery cells may be a pouch-type battery cell.

Each battery module may have a configuration in which a plurality of battery cells and a plurality of cartridge blocks are stacked. In the stacked configuration, one battery cell may be disposed on each of the opposite sides of each cartridge block.

In addition, in each battery module, sensing blocks (not shown) may be respectively disposed on opposite sides of a stacked body of the battery cells and the cartridge blocks forming the battery module. Each of the sensing blocks may be covered by a sensing block case 114.

Referring to FIG. 1, the six sensing block cases 114 are in the assembled state. Since each of the sensing block cases 114 covers a corresponding one of the sensing blocks respectively disposed in the battery modules, the number of battery modules may be six, which is the same as the number of sensing block cases 114.

Furthermore, each battery module has six cartridge blocks (six cartridge blocks are disposed in each sensing block case, reference numeral “111” in FIG. 3 and FIG. 4). When each of the battery cells (reference numeral “109” in FIG. 4) is disposed on a corresponding one of the opposite sides of each cartridge block, the number of battery cells in each battery module may be 12.

The above-described configuration is an example, and the present disclosure is not limited thereto. The number of battery cells and cartridge blocks forming each battery module may be varied.

The inlet duct 120 is coupled to the upper side of the cell cartridge assembly 110. The inlet duct 120 has a shape extending in a direction in which the cartridge blocks 111 of the cell cartridge assembly 110 are stacked. Accordingly, the longitudinal direction of the inlet duct 120 may be a direction in which the cartridge blocks 111 are stacked.

The cooling air inlet 121 is formed at one end of the inlet duct 120 in the longitudinal direction. The inlet duct 120 is assembled to cover the cell cartridge assembly 110 from the upper side of the cell cartridge assembly 110. In the assembled state, a sealed space is formed between the inlet duct 120 and the upper side of the cell cartridge assembly 110.

The outlet duct 130 is coupled to the other end of the cell cartridge assembly 110 in the longitudinal direction so as to be located on the opposite side of the cooling air inlet 121 of the inlet duct 120. The inlet side of the outlet duct 130 is coupled to the lower end side of the cell cartridge assembly 110. The outlet side of the outlet duct 130 is coupled to the blower 140.

Regarding the flow state of air, when the blower 140 is driven for cooling performance, air is suctioned into the cooling air inlet 121 of the inlet duct 120 by the blower 140. The air suctioned through the cooling air inlet 121 moves along the lower surface of the inlet duct 120 through a space defined between the inlet duct 120 and the cell cartridge assembly 110.

Air moves in the longitudinal direction of the battery pack assembly 100. During air movement, air is distributed from the sealed space on the upper side of the cell cartridge assembly 110 to the cooling passage 112 of each of the cartridge blocks 111 in the stacked state. Thereafter, air is introduced into a space between the battery cells 109 through the cooling passage 112 of the cartridge block 111 and then passes through the space between the battery cells in the downward direction.

In this manner, while air passes through the space between the battery cells, the battery cells are cooled by air. Further, air that cools the battery cells is discharged to the lower sides of stacked cartridge blocks and then moves toward the outlet duct 130. Thereafter, air moves to the blower 140 along the outlet duct 130 and is finally discharged through an outlet 141 provided on one side of the blower 140.

The present disclosure is intended to provide a battery pack assembly configured to uniformly cool all the battery cells by uniformly distributing air regardless of the positions of the cartridge blocks and the battery cells relative to the position of the inlet duct.

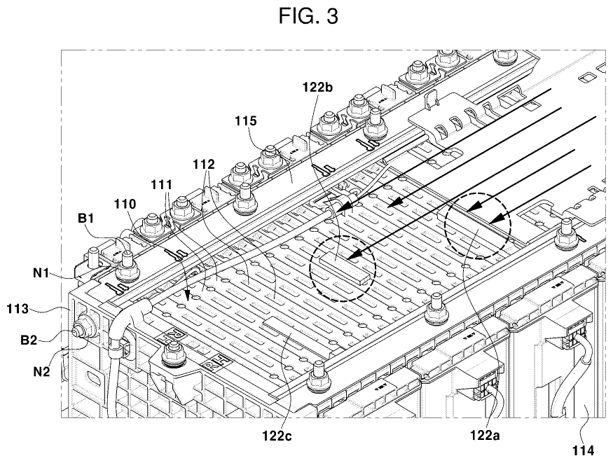

FIG. 2 is a view showing a state in which the flow resistance members are installed on the lower surface of the inlet duct according to an embodiment of the present disclosure. FIG. 3 is a perspective view showing the positions at which the flow resistance members are disposed on the upper side of the cell cartridge assembly in a state in which the inlet duct is assembled according to an embodiment of the present disclosure. FIG. 4 is a cross-sectional view showing the battery cells and the cartridge blocks of the cell cartridge assembly according to an embodiment of the present disclosure.

FIG. 3 shows the positions of the flow resistance members 122a, 122b, and 122c in the state in which the inlet duct is assembled, and particularly shows the positions of the flow resistance members 122a, 122b, and 122c relative to the cell cartridge assembly 110.

As shown in FIG. 2, the flow resistance members 122a, 122b, and 122c may be disposed on the surface facing one side surface of the cell cartridge assembly 110. For example, the flow resistance members 122a, 122b, and 122c may be installed on the lower surface of the inlet duct 120 facing one side surface of the cell cartridge assembly 110.

The flow resistance members 122a, 122b, and 122c may be disposed at positions spaced upwards from the cell cartridge assembly 110. In FIG. 3, the inlet duct is omitted to show the arrangement state of the flow resistance members 122a, 122b, and 122c and the positions thereof relative to the cell cartridge assembly 110.

Each of the flow resistance members 122a, 122b, and 122c is installed at a fixed position on the lower surface of the inlet duct 120 with a predetermined length, width, and thickness (height), as shown in FIG. 2. Each of the flow resistance member 122a, 122b, and 122c may be installed on the lower surface of the inlet duct 120 so as to extend in a traverse direction.

The traverse direction is a traverse direction relative to the longitudinal direction of the inlet duct 120. If the longitudinal direction of the battery pack assembly 100 and the inlet duct 120 is referred to as a vertical direction, the traverse direction (longitudinal direction of each of the flow resistance members) may be a direction perpendicular to the vertical direction.

As described above, since the cooling air inlet 121 through which air, which is a cooling fluid, is introduced is located at one end of the inlet duct 120, air introduced through the cooling air inlet 121 flows approximately in the longitudinal direction of the inlet duct 120 along the lower surface of the inlet duct 120 in the space between the inlet duct 120 and the cell cartridge assembly 110. In this case, the flow resistance members 122a, 122b, and 122c are installed on the lower surface of the inlet duct 120 so as to extend in the traverse direction crossing the flow direction of air.

Referring to FIG. 2, it may be seen that three flow resistance members 122a, 122b, and 122c are spaced apart from each other at predetermined intervals on the lower surface of the inlet duct 120. Each of the flow resistance members 122a, 122b, and 122c is installed to extend in the traverse direction perpendicular to the longitudinal direction of the inlet duct 120.

Each of the flow resistance members 122a, 122b, and 122c may be made of synthetic rubber. As a specific example, each of the flow resistance members 122a, 122b, and 122c may be made of ethylene propylene diene monomer (EPDM) having excellent durability and heat resistance.

FIG. 2 shows an example in which three flow resistance members 122a, 122b, and 122c are installed, and the present disclosure is not limited thereto. The number, position, length, width, thickness, spacing, and the like of the flow resistance members may be changed in various ways depending on specifications such as a size or a shape of the inlet duct 120, a gap between the inlet duct 120 and the cell cartridge assembly 110, and a size or a shape of the battery pack assembly 100.

In FIG. 2, a reference sign “H” represents a bolt hole, in FIG. 3, reference signs “B1” and “B2” represent bolts of the cell cartridge assembly 110, and reference signs “N1” and “N2” represent nuts. The inlet duct 120 is coupled to the cell cartridge assembly 110 in a state in which the entire circumference of the edge of the inlet duct 120 is seated on the upper edge of the cell cartridge assembly 110.

In this case, the bolt B1 of the cell cartridge assembly 110 is inserted into the bolt hole H of the inlet duct 120, and then the nut N1 is fastened to the bolt B1, thereby fixing the inlet duct 120 to the cell cartridge assembly 110.

More specifically, in the cell cartridge assembly 110, upper support bars 115 are installed along opposite edges of the upper end of a cartridge block stack formed by stacking the cartridge blocks 111. The inlet duct 120 may be coupled to the cell cartridge assembly 110 using the bolts B1 installed on the two upper support bars 115 respectively disposed on opposite sides of the cell cartridge assembly 110 and the nuts N1 fastened thereto.

In FIG. 3, reference numeral “113” denotes an end plate 113. In FIG. 4, reference numeral “109” denotes the battery cell 109. In the cell cartridge assembly 110, the end plates 113 are respectively coupled and fixed to the opposite ends of a stacked body in which the cartridge blocks 111 and the battery cells 109 are stacked. Each of the end plates 113 may be fixed to the cell cartridge assembly 110 by the bolt B2 installed on the upper support bar 115 and the nut N2 fastened thereto.

In FIG. 3 and FIG. 4, reference numeral “111” denotes the cartridge block 111, and reference numeral “112” denotes the cooling passage 112 formed in the cartridge block 111. As shown in the drawing, a plurality of the cooling passages 112 may be formed to be arranged at regular intervals in the cartridge blocks 111 of the cell cartridge assembly 110.

Accordingly, air introduced through the cooling air inlet 121 of the inlet duct 120 is distributed to the cooling passages 112 of the cartridge blocks 111 in the space between the inlet duct 120 and the cell cartridge assembly 110. In this case, air moving along the lower surface of the inlet duct 120 flows into the cooling passages 112. Thereafter, air passes through the cooling passages 112 in the downward direction so as to cool the battery cells 109.

Next, a description is given as to a manufacturing method of the battery pack assembly. In the manufacturing method, while air blown by the blower flows through the cooling air inlet of the inlet duct, air is uniformly distributed to the cooling passages of all the cartridge blocks regardless of the positions of the cartridge blocks and the battery cells, thereby making it possible to uniformly cool all the battery cells.

In order to manufacture the battery pack assembly capable of performing uniform cooling, the temperatures of all the cartridge blocks are measured during blower operation in the battery pack assemblies each having the same specifications. Then, the optimal position, length, and thickness (height) of the flow resistance member are determined based on the temperature measurement results. Thereafter, the flow resistance member having the determined optimal position, length, and thickness is installed on the lower surface of the inlet duct.

The inventor determined the optimal position of the flow resistance member on the lower surface of the inlet duct in consideration of the following facts:

First, based on the air flow direction in the space formed between the inlet duct and the cell cartridge assembly of the battery pack assembly, when the flow resistance member serving as an air dam is disposed at a position downstream of a position of a battery cell having a relatively high temperature and a position of the corresponding cartridge block, more air may flow into a cooling passage formed in the cartridge block having the high temperature. A cooling effect is thereby improved on the corresponding cartridge block and the battery cell.

Second, when the flow resistance member is disposed at a position upstream of a position of a battery cell having a relatively low temperature and a position of the corresponding cartridge block, less air may flow into a cooling passage formed in the cartridge block having the lower temperature. A cooling effect is thereby reduced on the corresponding cartridge block and the battery cell.

After determining the optimal position of the flow resistance member, the inventor set forth to manufacture the battery pack assembly capable of uniformly cooling all the battery cells by installing the flow resistance member at the optimal position determined as described above.

More specifically, as a first step, the temperature of at least one of the battery cell and the cartridge block is measured using battery pack assemblies each having the same specifications. In each of the battery pack assemblies, the flow resistance members 122a, 122b, and 122c are not installed on the inlet duct 120. For example, a temperature sensor may be installed to measure the temperatures of all the battery cells 109 or all the cartridge blocks 111.

However, the above-described method is only an example. Any method may be used as long as the method may measure the temperature of each cartridge block 111 or may determine the imbalance of cooling temperature across all the cartridge blocks 111.

In this case, the temperature of each cartridge block 111 is measured in the operation state (discharging or charging) of the battery pack assembly and the operation of the blower. Through the measured temperature, the position of the cartridge block 111 requiring adjustment of the cooling temperature is determined. Instead of the cartridge block 111, the temperature of the battery cell 109 may be measured using a temperature sensor.

The cartridge block requiring adjustment of the cooling temperature means a cartridge block having an excessively high or low temperature compared to other cartridge blocks (when the temperatures of the cartridge blocks are measured), or a cartridge block including a battery cell, the temperature of which is excessively high or low compared to other battery cells (when the temperatures of the battery cells are measured).

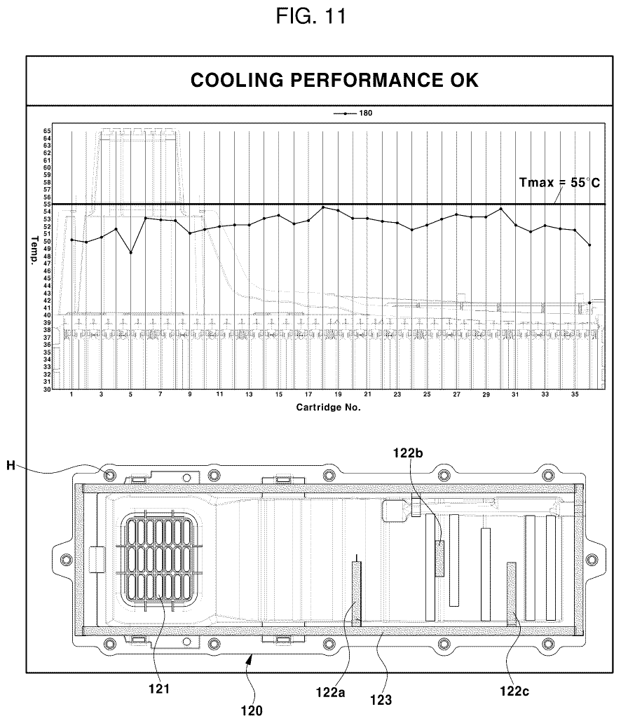

The position of the cartridge block, the temperature of which is excessively high compared to other cartridge blocks, may mean a position having a temperature higher than a target cooling temperature (“Tmax=55° C.” in FIG. 10), which is a predetermined reference value, among the measured temperatures of the cartridge blocks (or battery cells). More specifically, this may mean a position having a peak value of the temperature among the temperatures higher than the target cooling temperature.

In this manner, the temperatures of all the cartridge blocks 111 are measured while the battery pack assembly 100 is cooled by operating the blower 140. It is thereby possible to determine the imbalance state of the cooling temperature across all the cartridge blocks and battery cells.

In addition, based on information on the measured temperature, it is possible to determine the position of the cartridge block 111, the temperature of which is higher or lower than an allowable limit compared to a target cooling temperature value.

The target cooling temperature may be “Tmax” in FIG. 10 and FIG. 11 to be described below. This target cooling temperature is a preset temperature. In the examples of FIG. 10 and FIG. 11, 55° C. is set as the target cooling temperature, but this is an example and the present disclosure is not limited thereto. The target cooling temperature may be varied depending on the type or specifications of the battery cells used in the battery pack assembly 100.

Next, as a second step, characteristics such as the arrangement position, length, and/or thickness of the flow resistance member capable of lowering or increasing the cooling temperature of the corresponding cartridge block may be determined. A position downstream of a cooling air flow direction of a battery cell or a cartridge block having a temperature value higher than the target cooling temperature value in the temperature measurement results may be determined as the arrangement position of the flow resistance member.

The arrangement position of the flow resistance member may be determined as a position downstream of a position of a cartridge block having a peak value of the actually measured temperature as shown in FIG. 10, which is described below. In other words, the arrangement position of the flow resistance member may be determined as a position downstream of a position of a cartridge block having the temperature of a peak value higher than the target cooling temperature value. Alternatively, the arrangement position of the flow resistance member may be determined as a position downstream of a position of a cartridge block having a temperature higher than an allowable limit of the target cooling temperature.

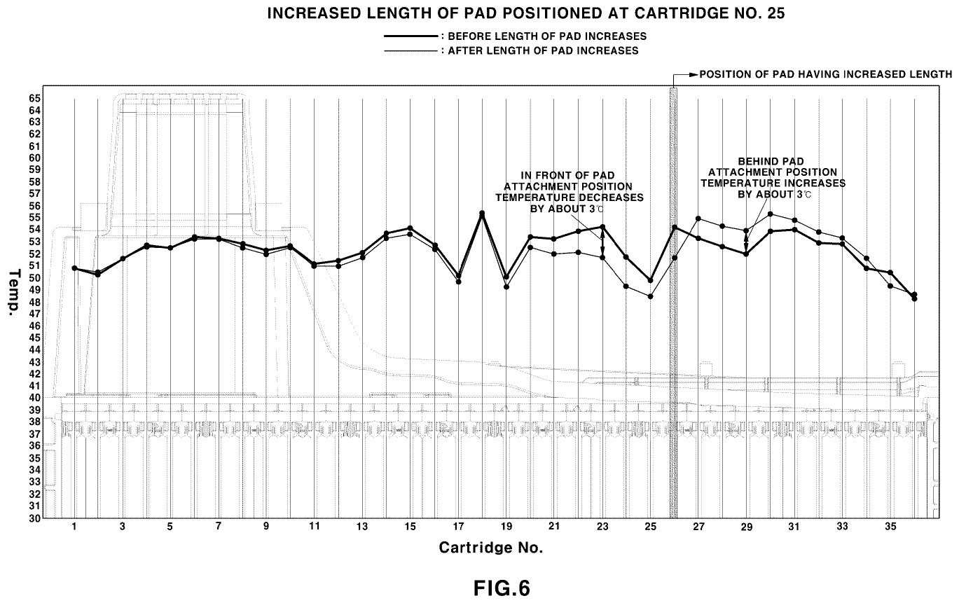

FIG. 5 shows the temperatures of all the cartridge blocks. The temperatures are measured in a battery pack assembly in which a flow resistance member is not used as in the prior art and a battery pack assembly in which a single flow resistance member is attached to the lower surface of an inlet duct.

In FIG. 5, a “pad” refers to each of the flow resistance members 122a, 122b, and 122c, and a “cartridge” refers to each of the cartridge blocks 111. Each of the flow resistance members 122a, 122b, and 122c may be an EPDM pad. The flow resistance members 122a, 122b, and 122c may be attached to the lower surface of the inlet duct 120 by using an adhesive (sticker adhesion method).

In FIG. 5, “No. 21” indicates the 21st cartridge block and a location thereof when numbers are assigned to the respective cartridge blocks 111 in order from one position on the side where the cooling air inlet 121 is located in the battery pack assembly 100. A “Tmax section” in FIG. 5 may be a section having a peak temperature among the actually measured temperatures.

As shown in FIG. 5, a temperature difference occurs between the cartridge blocks 111 respectively located in front of and behind the EPDM pads, which are the flow resistance members 122a, 122b, and 122c, are installed. The temperature difference occurs because each of the EPDM pads serves as an air dam that partially blocks air, which is a cooling fluid, and causes the air temporarily to stay on the upstream side.

Therefore, as described above, as compared with the cooling passages 112 of the cartridge blocks 111 located on the downstream side of the EPDM pads, more cooling fluid may flow into the cooling passages 112 of the cartridge blocks 111 located on the upstream side of the EPDM pads. As a result, the cartridge blocks on the upstream side are cooled more than those on the downstream side. Additionally, since relatively less cooling fluid flows into the cartridge blocks located on the downstream side of the EPDM pads, the cartridge blocks on the downstream side are cooled less.

According to a temperature graph in FIG. 5, when the EPDM pad, which is the flow resistance member, is attached to the cartridge block No. 21, it may be seen that the temperature of the cartridge block significantly decreases at an upstream position (“Tmax section”) right in front of the cartridge block No. 21.

In addition, it may be seen that the temperature decreases overall in the cartridge blocks (from the cartridge block No. 1 to the cartridge block No. 20) located upstream of the cartridge block No. 21. Conversely, it may be seen that the temperature increases overall in the cartridge blocks (from the cartridge block No. 22) located downstream of the cartridge block No. 21.

In this manner, a position at which the flow resistance member needs to be attached may be determined based on a temperature measurement value for each cartridge block measured in the first step Further, it is possible to determine, based on the temperature measurement value, a position at which the EPDM pad, which is the flow resistance member, is attached to the lower surface of the inlet duct.

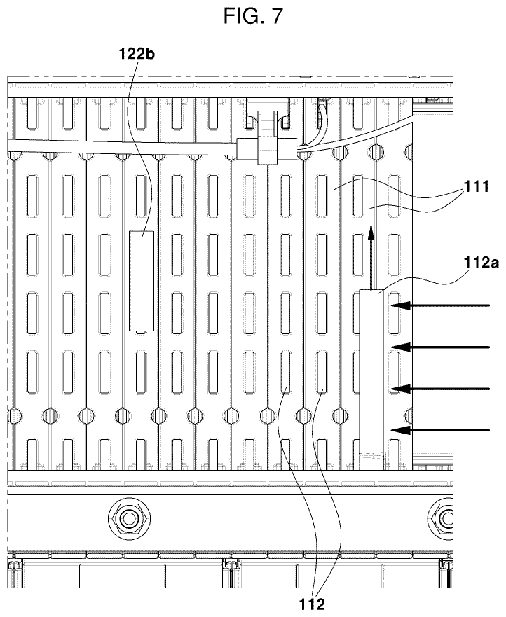

Hereinafter, a method of determining a length of the flow resistance member is described. FIG. 6 is a view showing the temperature of each cartridge block measured by varying the length of the flow resistance member installed in the battery pack assembly according to an embodiment of the present disclosure.

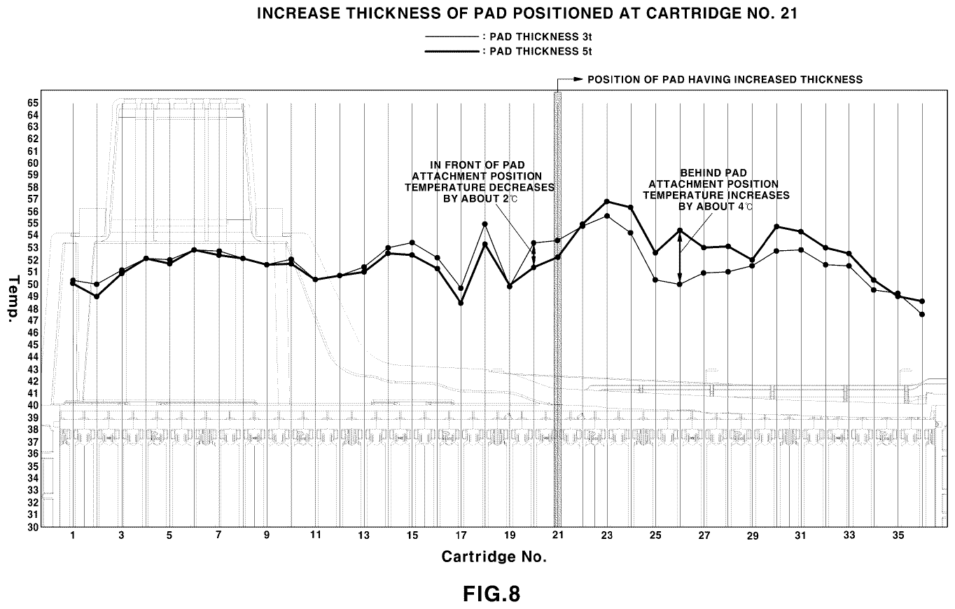

FIG. 7 is a plan view of the cell cartridge assembly showing the position of the flow resistance member according to an embodiment of the present disclosure. FIG. 7 shows only the two flow resistance members 122a and 122b among the flow resistance members 122a, 122b and 122c shown in FIG. 2. An arrow shown in the longitudinal direction of the flow resistance member 122a in FIG. 7 indicates a direction of increasing the length of the flow resistance member 122a.

Even if the EPDM pad, which is the flow resistance member, is attached to the same position in the inlet duct, it was found that the cooling degrees and the temperatures of the cartridge blocks respectively located in front of and behind the EPDM pad varied depending on the length of the EPDM pad. Through this configuration, it was confirmed that the length of the EPDM pad affects the cooling degree and the temperature of the cartridge block.

The temperature graph in FIG. 6 shows the temperatures of all the cartridge blocks measured by varying the length of the EPDM pad attached to the same position. Referring to FIG. 6, it was found that greater flow resistance performance was achieved by increasing the length of the EPDM pad.

Therefore, the length of the flow resistance member may be determined depending on a temperature difference value between the adjacent battery cells or between the adjacent cartridge blocks in the temperature measurement results described above. For example, a relatively long EPDM pad may be attached between the cartridge blocks having a large temperature difference, and a relatively short EPDM pad is attached between the cartridge blocks having a small temperature difference, thereby achieving a more uniform temperature gradient.

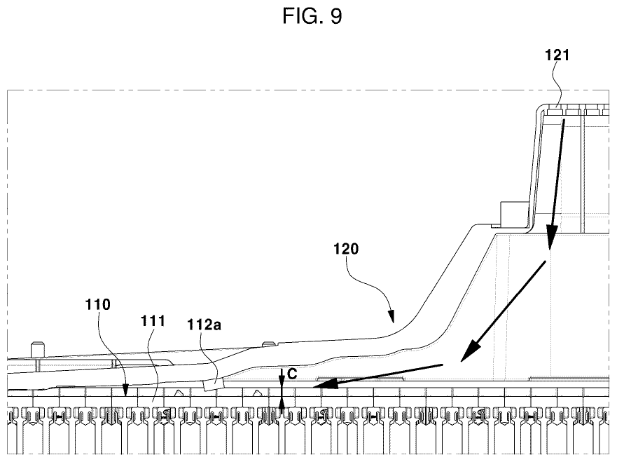

Additionally, regarding the thickness of the flow resistance member, FIG. 8 is a view showing the temperature of each cartridge block measured by varying the thickness of the flow resistance member installed in the battery pack assembly according to an embodiment of the present disclosure.

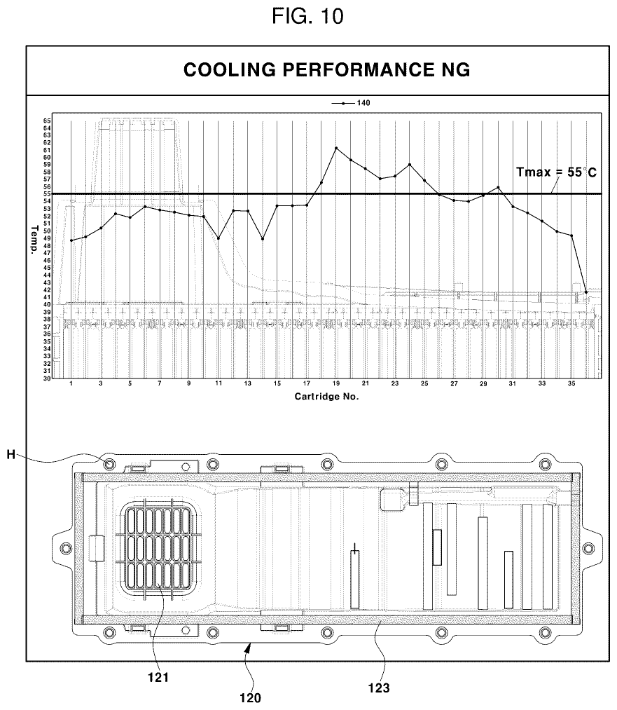

FIG. 9 is a view showing the flow state of air introduced through the cooling air inlet of the inlet duct in the battery pack assembly according to an embodiment of the present disclosure. FIG. 9 shows a state in which air, which is a cooling fluid, flows along the lower surface of the inlet duct 120 in the space between the inlet duct 120 and the cartridge block 111. In addition, FIG. 9 shows a gap C between the lower surface of the EPDM pad, which is the flow resistance member 122a, and the upper surface of the cartridge block 111.

As a result of measuring the temperature by varying the thickness of the EPDM pad, which is the flow resistance member 122a, as shown in FIG. 8, it was found that, even if the EPDM pads having the same position and length were attached, the cooling degrees and the temperatures of the cartridge blocks respectively located in front of and behind the EPDM pad varied depending on the thickness (3t, 5t) of the EPDM pad. Through this configuration, it was confirmed that the thickness of the EPDM pad affects the cooling degree and the temperature of the cartridge block 111.

If the thickness of the EPDM pad, which is the flow resistance member, increases, the gap C between the lower surface of the EPDM pad and the upper surface of the cartridge block decreases. As shown in FIG. 9, air flowing along the lower surface of the inlet duct 120 after being introduced through the cooling air inlet 121 of the inlet duct 120 is subjected to greater flow resistance. Therefore, the thickness of the flow resistance member may be determined depending on a temperature difference value between the adjacent battery cells or between the adjacent cartridge blocks in the temperature measurement results described above. For example, a relatively thick EPDM pad may be attached between the adjacent cartridge blocks having a large temperature difference, and a relatively thin EPDM pad is attached between the adjacent cartridge blocks having a small temperature difference, thereby achieving a more uniform temperature gradient.

Then, as a third step, on the basis of the temperature imbalance information of the cartridge blocks and the battery cells identified through the temperature measurement process (in the first step), the optimal position, length, and thickness of the flow resistance member to achieve a uniform temperature state are determined (in the second step). Then the flow resistance member is attached to the lower surface of the inlet duct so as to achieve the determined optimal position, length, and thickness.

For example, when the position of the cartridge block having a peak temperature is determined through the temperature measurement process, the flow resistance member is attached to the lower surface of the inlet duct corresponding to the determined downstream position of the cartridge block. In this case, the position of the lower surface of the inlet duct to which the flow resistance member is attached may be a position directly above the cartridge block at the downstream position.

In addition, there is no limit to the method of attaching the flow resistance member. An attachment method using an adhesive is efficient in terms of cost and work time. For example, as a sticker-type attachment method, a method of attaching the EPDM pad having an adhesive applied to one side thereof to the lower surface of the inlet duct may be used in the same manner as attaching a sticker.

Hereinafter, a description is given as to an effect obtained when the flow resistance member is attached to the inlet duct in the battery pack assembly according to an embodiment of the present disclosure. FIG. 10 and FIG. 11 are views each showing the result of measuring the temperatures of all the cartridge blocks in the battery pack assembly of the related art and an embodiment of the present disclosure.

In FIGS. 10 and 11, “Tmax=55° C.” indicates that a target cooling temperature is 55° C. Additionally, in FIG. 10 and FIG. 11, reference numeral “123” denotes a sealing member installed along the entire circumference of the edge of the inlet duct 120.

After the edge of the inlet duct 120 is coupled to the upper edge of the upper surface of the cell cartridge assembly (reference numeral “110” in FIGS. 1 and 9), a space between the inlet duct 120 and the cell cartridge assembly is completely sealed by the sealing member 123.

Cooling performance of the battery cell of the conventional battery pack assembly and cooling performance of the battery cell of the battery pack assembly of the present disclosure are compared with each other with reference to FIGS. 10 and 11. As shown in FIG. 10, in the conventional battery pack assembly, a temperature difference value between the cartridge blocks is very large.

Referring to FIG. 10, in the case of a cartridge block located at the farthest distance from the cooling air inlet 121 of the inlet duct 120 in the longitudinal direction of the cell cartridge assembly, a relatively large amount of air is distributed and introduced into a cooling passage of the corresponding cartridge block, and the lowest temperature is shown at the position of the cartridge block.

However, in the case of a cartridge block approximately located at a middle distance from the cooling air inlet 121 of the inlet duct 120 in the longitudinal direction of the cell cartridge assembly, since air introduced through the cooling air inlet 121 of the inlet duct 120 passes through the upper space of the cartridge block at a relatively higher speed, there is a great amount of air that is not introduced into a cooling passage of the corresponding cartridge block.

Therefore, the amount of air distributed and introduced into the cooling passage of the cartridge block located at the middle distance is relatively small. Accordingly, cooling performance is poor in the battery cell located at the middle distance from the cooling air inlet 121 of the inlet duct 120 in the longitudinal direction of the cell cartridge assembly. As a result, the temperature of the cartridge block located at the middle distance from the cooling air inlet 121 of the inlet duct 120 is too high.

The optimal position, length, and thickness (height) of the flow resistance member are determined based on the temperature measurement results shown in FIG. 10. The flow resistance member having the determined position, length, and thickness is installed, thereby making it possible to achieve uniform cooling performance for all the battery cells.

Referring to FIG. 11, the flow resistance members 122a, 122b, and 122c each serving as an air dam are respectively installed at positions each having a relatively high temperature in the conventional battery pack assembly in which the flow resistance member is not installed, i.e., at positions downstream of an air flow path from the positions each having the peak temperature in the temperature measurement graph in FIG. 10.

As a result, each of the flow resistance members 122a, 122b, and 122c acts as a resistance member and serves as an air dam to partially block air introduced through the cooling air inlet 121 of the inlet duct 120, thereby allowing more air to be introduced into the intermediate cooling passages. As a result, it is possible to uniformly distribute air and to achieve uniform cooling performance regardless of the positions of the battery cells relative to the position of the cooling air inlet 121.

In this manner, when the flow resistance member is installed, the position, length, and thickness of the flow resistance member are adjustably attached based on the temperature measurement results. It is thereby possible to achieve optimal cooling uniformity in accordance with various variables such as the number of battery cells, the shape of the cartridge block, and the shape of the inlet duct.

As is apparent from the above description, the present disclosure provides a battery pack assembly capable of uniformly distributing air introduced into a space between an inlet duct and cartridge blocks regardless of the positions of the cartridge blocks and battery cells relative to a cooling air inlet, thereby having an effect of uniformly cooling all the battery cells and achieving stable cooling performance.

Although the technical concepts or the disclosure have been described in detail with reference to embodiments thereof, the scope of the present disclosure is not limited to the embodiments. It should be appreciated by those having ordinary skill in the art that changes may be made in these embodiments without departing from the principles and spirit of the disclosure, the scope of which is defined in the appended claims and equivalents thereto.

What is claimed is:

1. A battery pack assembly comprising:
a cell cartridge assembly comprising one or more battery cells, one or more cartridge blocks configured to fix the battery cells, and cooling passages configured to allow cooling air for cooling of the one or more battery cells to flow therethrough;
an inlet duct comprising a cooling air inlet, wherein the inlet duct is coupled to one side surface of the cell cartridge assembly so as to form a flow space therebetween, and wherein the flow space is configured to allow the cooling air inlet and the cooling passages to communicate with each other and guide the cooling air introduced through the cooling air inlet to the cooling passages; and
a flow resistance member configured to block at least a part of the cooling air flowing along the flow space.

2. The battery pack assembly of claim 1, wherein the flow resistance member is disposed on a surface facing the one side surface of the cell cartridge assembly.

3. The battery pack assembly of claim 1, wherein the flow resistance member extends in a traverse direction relative to a flow direction of the air flowing along the flow space.

4. The battery pack assembly of claim 1, wherein the flow resistance member is an ethylene propylene diene monomer (EPDM) pad and is attached to the inlet duct with an adhesive.

5. The battery pack assembly of claim 1, wherein:
the cell cartridge assembly is formed by stacking a plurality of the battery cells and a plurality of the cartridge blocks,
the inlet duct has a shape extending in a stacking direction of the battery cells and the cartridge blocks, and
the cooling air inlet is disposed at one end of the inlet duct in the stacking direction.

6. The battery pack assembly of claim 5, wherein the inlet duct is inclined toward the cell cartridge assembly in a direction going away from the cooling air inlet and approaching the cell cartridge assembly.

7. The battery pack assembly of claim 1, further comprising a blower configured to forcibly flow the cooling air.

8. The battery pack assembly of claim 7, further comprising an outlet duct disposed on the other side surface of the cell cartridge assembly.

9. The battery pack assembly of claim 8, wherein the blower is disposed on a side of the outlet duct.

10. A manufacturing method for manufacturing the battery pack assembly of claim 1, the manufacturing method comprising determining a characteristic of the flow resistance member by:
a first step of measuring temperatures of one or more of the cartridge blocks or one or more of the battery cells; and
a second step of determining, based on measurement results of the temperatures, one or more of an arrangement position, a thickness, or a length of the flow resistance member.

11. The manufacturing method of claim 10, wherein the second step includes determining the arrangement position of the flow resistance member, wherein a position downstream of a cooling air flow direction of any one of the cartridge blocks or the battery cells having a temperature value based on the measurement results of the temperatures is determined as the arrangement position of the flow resistance member, and wherein the temperature value is higher than a predetermined target cooling temperature value.

12. The manufacturing method of claim 11, wherein, the second step includes determining the thickness of the flow resistance member, and wherein the thickness of the flow resistance member is determined depending on a temperature difference value between adjacent cartridge blocks or between adjacent battery cells based on the measurement results of the temperatures.

13. The manufacturing method of claim 10, wherein, the second step includes determining the length of the flow resistance member, and wherein the length of the flow resistance member is determined depending on a temperature difference value between adjacent cartridge blocks or between adjacent battery cells based on the measurement results of the temperatures.
